(19) United States
(12) Patent Application Publication
(10) Pub. No.: US 2013/0073361 A1
(43) Pub. Date: Mar. 21, 2013

(54) Methods and systems for offering targeted deals to customers and real-time automatic redemption thereof

(71) Applicant: Jonathan Silver, Mamaroneck, NY (US)

(72) Inventor: Jonathan Silver, Mamaroneck, NY (US)

(21) Appl. No.: 13/623,871

(22) Filed: Sep. 20, 2012

Related U.S. Application Data
(60) Provisional application No. 61/650,457, filed on May 22, 2012.
(60) Provisional application No. 61/608,638, filed on Mar. 8, 2012.
(60) Provisional application No. 61/608,636, filed on Mar. 8, 2012.
(60) Provisional application No. 61/650,454, filed on May 22, 2012.
(60) Provisional application No. 61/566,253, filed on Dec. 2, 2011.
(60) Provisional application No. 61/566,262, filed on Dec. 2, 2011.
(60) Provisional application No. 61/537,049, filed on Sep. 20, 2011.

(51) Int. Cl. G06Q 30/02

(52) U.S. Cl. 705/14.17

(57) ABSTRACT

A coupon on a card method for redeeming a spot on voucher comprises a step of providing a card product issued by a financial institution to a cardholder, and providing an offer, wherein the offer is a coupon. The offer is transmitted from a financial institution server to an electronic device of the cardholder. Cardholder purchase information is received. The cardholder purchase information indicates that the cardholder purchased the offer. A redemption choice is received from the cardholder. The redemption choice is to load the coupon on the cardholder's card product. The cardholder's purchase information is stored in an offer deployment system. A transaction approval request is receive from at least one of a merchant, an acquirer, an association, a bank, and an issuer. The transaction approval request is processed wherein the step of processing comprises at least one of querying the offer deployment system, approving the transaction, and applying the value of the offer. A receipt is issued to the cardholder wherein the receipt indicates the purchase and use of the coupon.

This application claims the benefit of the following U.S. Provisional Patent Applications, all of which are hereby incorporated by reference: App. No. 61/650,457 filed on Jun. 4, 2012; App. No. 61/608,638 filed on Mar. 8, 2012; App. No. 61/608,636 filed on Mar. 8, 2012; App. No. 61/650,454 filed on May 22, 2012; App. No. 61/566,253 filed on Dec. 2, 2011; App. No. 61/566,262 filed on Dec. 2, 2011; and App. No. 61/537,049 filed on Sep. 20, 2011.

### BACKGROUND

E-coupons, daily deal websites, and other coupons, offers, discounts, and deals have grown in popularity with both consumers and retailers. For example, consumers use such offers to purchase items at a discount. For retailers, offers such as these provide a means to draw in new customers, build and maintain customer loyalty, and provide some data that is useful for market research and the like.

Despite their popularity, consumers, retailers, and marketers are often unable to realize the full benefit of coupons. For example, in many instances, it is not possible to reliably measure how effective the coupons are in bringing in new customers and building loyalty. Furthermore, it can be inconvenient to use coupons. Even if a coupon was obtained electronically from a website or network connected computing device, the coupon would conventionally need to be printed or, at the very least, stored as a graphic image that can be shown (e.g. as in a photo or pdf file on the display of a smartphone) to a store clerk upon checkout.

Consumers are further inconvenienced because they must remember not only what coupons they have but also to bring their coupons when they visit a store at which it is redeemable. Additionally, processing conventional coupons can be burdensome to merchants because coupon processing is typically a manual process. Manual coupon processing also increases check-out time at a register resulting in longer wait times for customers, adds to the work in the back office, and increases the merchant's operating costs. Therefore, a need exists for methods and systems for allowing automatic redemption of coupons thereof.

In addition to the inconvenience of conventional coupons, consumers can be burdened when coupons are provided for goods or services that a customer is not likely to want and merchants may incur expenses offering coupons to those to whom they are unlikely to be relevant. Accordingly, a need also exists for methods and systems for offering targeted deals, such as in the form of coupons or offers, to consumers, particularly when combined with an automatic coupon redemption process.

### SUMMARY

A method for redeeming a coupon comprises a step of providing a card product issued by a financial institution to a cardholder, and providing an offer, wherein the offer is in the form of a coupon or other offer or voucher that can be applied to the purchase of goods or services. The offer is transmitted from a financial institution server to an electronic device of the cardholder. In one embodiment, the offer can be in the form of a voucher that can be purchased by the cardholder from the financial institution or a third party

The cardholder customer can access an Internet-accessible offer management system through a mobile computing device. The customer can select from coupons to them, such as offers made to the customer (which may need to be purchased), vouchers purchased by the customer, and the like. A redemption choice is received from the cardholder indicating one or more coupons to ‘load’ onto the cardholder's card product. Information about offers, coupons, vouchers, etc., loaded onto a cardholder's card product can be stored in an offer deployment system.

When the cardholder uses the card product to purchase a good or service, a transaction approval request is generated from at least one of a merchant, an acquirer, an association, a bank, and an issuer. The transaction approval request is processed wherein the step of processing comprises at least one of querying the offer deployment system which determines whether an offer loaded onto the cardholder's card product can be applied to the purchase. If so, the value of the offer is applied to the transaction. Preferably, offer value is applied to the amount of the transaction approval request before the request is received by the ultimate financial institution or card transaction processing system responsible for approving the transaction such that the amount of the transaction which must be approved is the purchase price of the good or service less the applied value of the offer. A receipt can be issued to the cardholder wherein the receipt indicates the purchase and use of the coupon.

### BRIEF DESCRIPTION OF THE DRAWINGS

FIG. 1 illustrates a prior art retail payment system and method.

FIG. 2 defines some of the participants in a retail payment system.

FIG. 3 depicts an exemplary mobile computing device suitable for use by a cardholder using the coupon on a card system as disclosed herein.

FIG. 4 illustrates various entities that can participate in a coupon on a card and real-time redemption system.

FIG. 5 is a method carried out by the system of FIG. 4 according to an aspect of the invention.

FIG. 6 is a flow chart that illustrates a method for obtaining an offer, connecting it to a card, and redeeming the offer.

FIG. 7A-B illustrates an exemplary receipt which includes the purchase price, instant redemption of the coupon, and what was actually owed by the customer.

FIGS. 10-14 are screenshots of customer interaction of a merchant funded rewards program.

FIG. 15A-B shows screenshots of a mobile application running on the exemplary mobile computing device of FIG. 3 such as an iPhone.

FIG. 16A-C shows screenshots of a mobile application running on the exemplary mobile computing device of FIG. 3 such as an Android phone.

### DETAILED DESCRIPTION

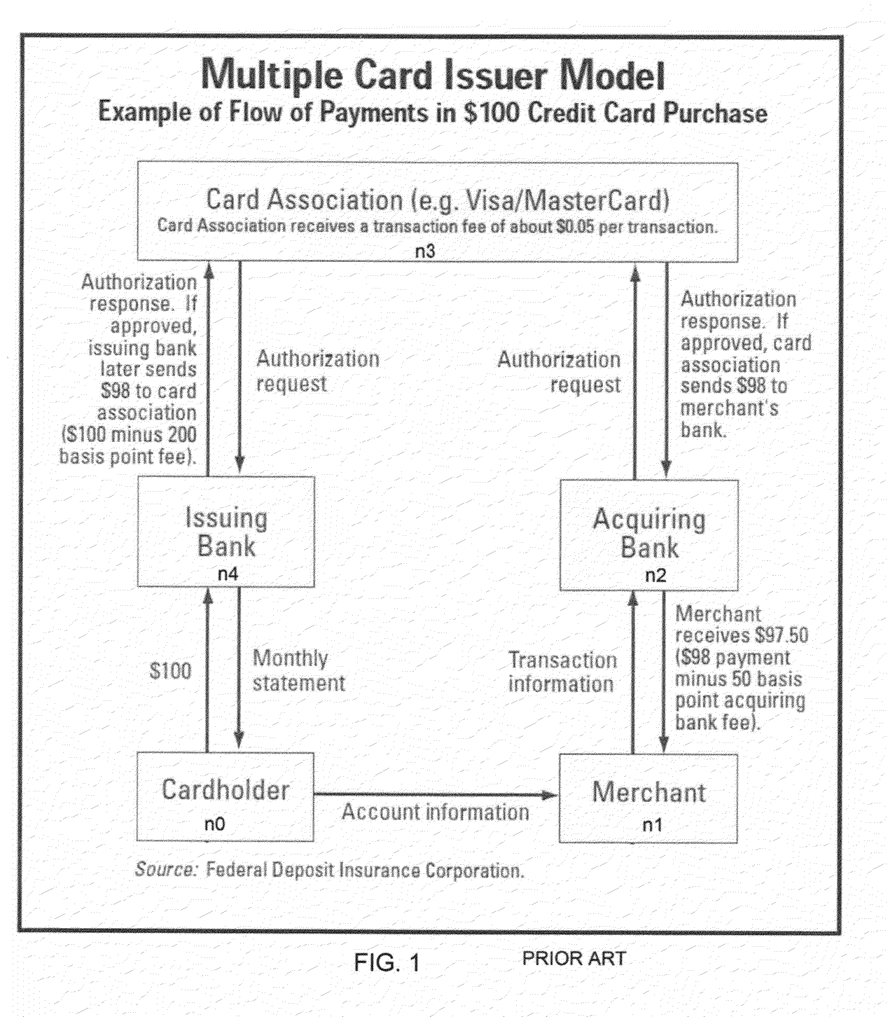

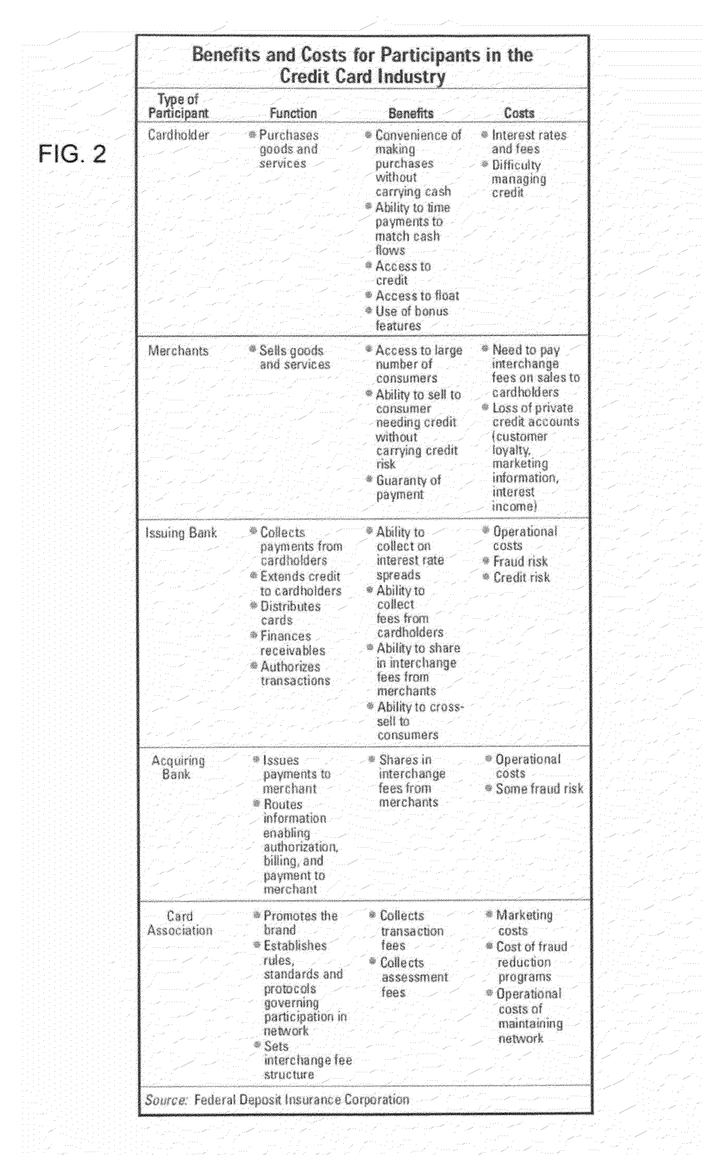

FIG. 1 discloses a conventional retail payment systems and method commonly used by businesses that accept any sort of “card” as payment. FIG. 2 provides information about various participants in a retail payment system such as shown in FIG. 1

Payment systems can comprise many components, including but not limited to: (a) card products such as credit cards and debit cards (“card(s)” or “card product(s)”); (b) electronic payment machines and processes, for example but not limited to electronic wallets, chip embedded cards, and smart cards (“card(s)” or “card product(s)”); (c) any electronic or written payment instrument (“instrument” or “payment instrument”) that can be used to obtain goods (the terms “product”, “service”, “goods”, and “item” are used interchangeably and equivalently herein); point of sale computers and terminals (“POS”); (d) authorization systems and processes (“authorization”); and (e) the entities and elements in and of the authorization stream of FIGS. 1 and 2 including but not limited to merchants (“merchant” or “retailer”), acquiring banks (“acquirer”), card associations (“association(s)”), issuing banks (“issuer”), gateways, and cardholders (“cardholder” or “customer” or “user”). The various electronic interactions, signaling, data flows, standards, practices, and protocols in and of the authorization stream are well understood by those having ordinary skill in the art. Any reference herein to a “card” or “card product” should be read and understood as equivalently covering an “instrument” or “payment instrument”. Additional information on payment systems compatible with the present invention is available from many source such as the following documents which are hereby incorporated by reference: “Merchant Acquirers and Payment Card Processors: A Look inside the Black Box,” Federal Reserve Bank of Atlanta Economic Review, First Quarter 2006, pp. 27-42; and “Non-Banks in the Payment Systems,” Federal Reserve Bank of Kansas City, November 2003, ISBN 0-9744809-1-6.

The methods and systems disclosed herein include a marketing system for financial institutions that allows for the delivery and electronically linking of offers directly to consumers' credit and debit cards and allows these offers to be redeemed in real time (“coupon-on-a-card”). The Coupon-on-a-Card™ system can significantly improve the effectiveness of consumer marketing initiatives and provide a significantly enhanced consumer experience. Coupons and offers can be initially directed to a consumer via a variety of methods. In a particular implementation, targeted marketing of deals is provided by the Affinity Spot ON Deals™ platform which is disclosed below,

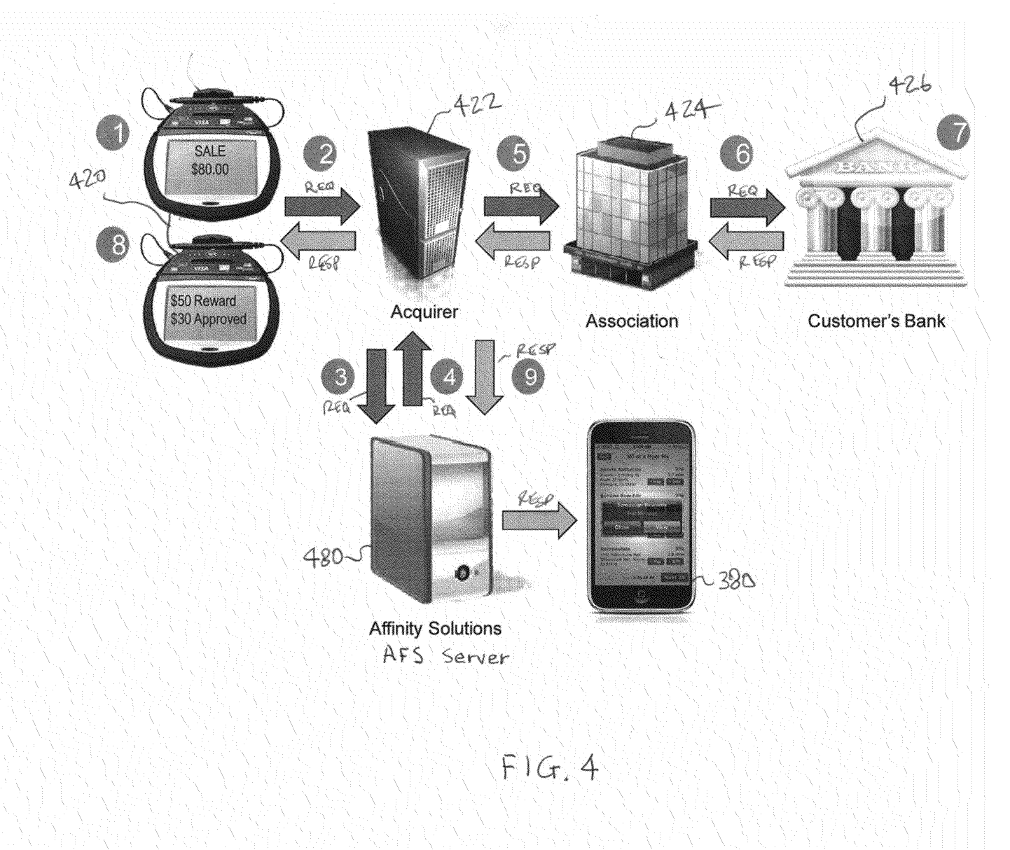

FIG. 4 illustrates a coupon on a card and real-time redemption system. The example of FIG. 4 is for a deal voucher “$50 for $25”. It is understood that the systems and methods disclosed herein operate with any type of offer (for example, but not limited, to coupons, discounts, vouchers, rewards, promotions, deals, rebates, etc.). The system includes a merchant's POS terminal 420. The POS terminal is in communication with an Acquirer 422. The Acquirer 422 is in communication with an Association 424 which is in communication with an FI such as the Customer's Bank 426. An AFS Server 480 is in communication with the Acquirer 422. The AFS Server 480 may also be in communication with the customers phone or other computing device 380.

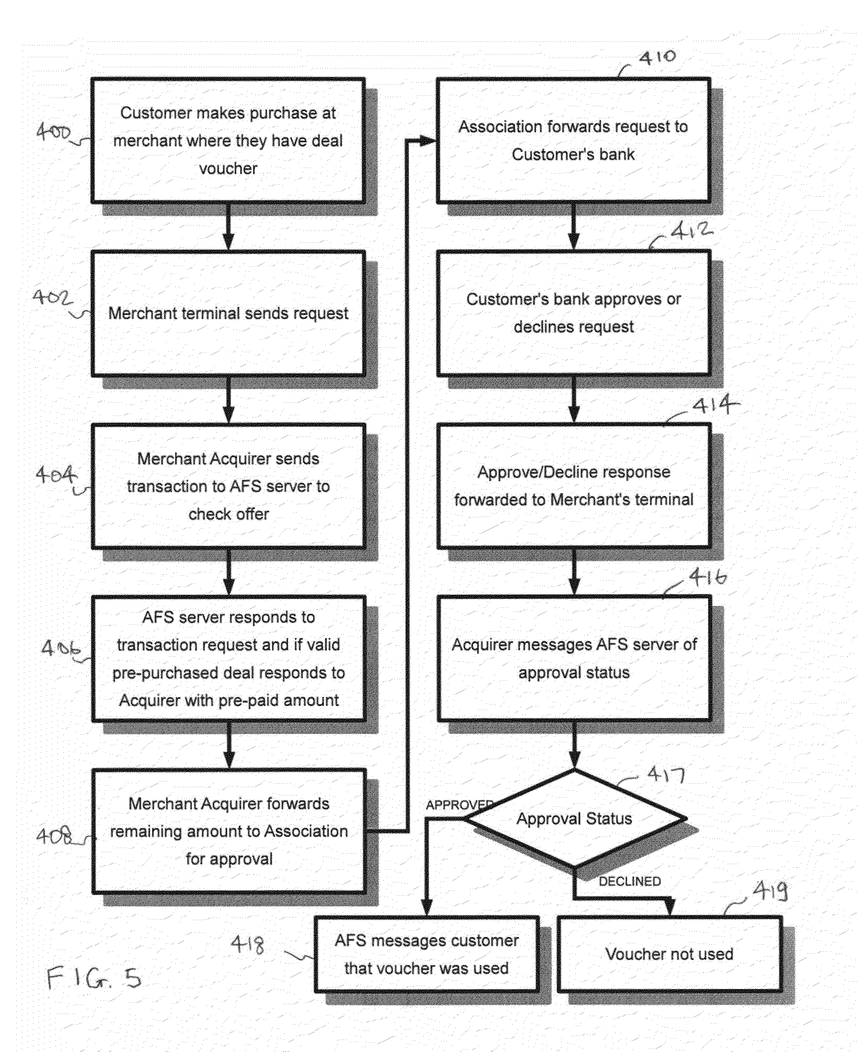

FIG. 5 is a method carried out by the system of FIG. 4.

With reference to FIGS. 4 and 5, a card product such as a credit or debit card is used to shop at a merchant and purchase a product. Before the user enters into a transaction with the merchant, an offer is linked to the card. For example, a user or customer of the card product can electronically connect an offer (equivalently referred to as a deal, coupon rebate, discount, or voucher; the offer is for a product and/or for use at a merchant) to the card product by logging onto a website hosted by server that maintains a user's account and offers available to the user to be linked to the card. In one example, the offer is purchased by the user before purchasing the product; the offer is purchased by the user at a first price but has a second price value that is greater than the first price.

Returning to FIGS. 4 and 5, the customer makes a purchase at the participating merchant (step 400 of FIG. 5). The merchant scans the customer's card at a terminal, for example a credit card is swiped at a credit card terminal. The Merchant's Terminal transmits the transaction (step 402), which is received at the Acquirer.

The Acquirer transmits the transaction to a server 480 (“AFS server”) comprising and/or configured to access a database of offers and merchants (step 404 of FIG. 5). The database is queried and the server 480 determines whether the offer at issue is valid based, e.g., on the transaction information, user, and possibly other criteria. Thus, if the transaction is associated with the offer, the AFS server transmits an authorization response indicating a transaction/offer validation and comprising offer information, such as the amount of the offer back, to the Acquirer (step 406 of FIG. 5).

Next, the Acquirer deducts the amount of the offer from the transaction price and transmits the remaining balance to the Association for approval (step 408 of FIG. 5). An example of an Association is a credit card association like Visa, MasterCard, and the like, or any Association having or managing any type of card product such as credit, debit, or prepaid card. The Association transmits the transaction balance to the Customer's Bank (step 410 of FIG. 5).

The Customer's Bank determines if the transaction should be approved or declined (step 412 of FIG. 5). An approve/decline status message is transmitted to the Merchant's Terminal (step 414 of FIG. 5). The signaling may be by way of one or more of the other nodes through one or more networks, such as the Internet, a private network, or a public network.

The Acquirer transmits a notification to the AFS server that the transaction was approved (step 416 of FIG. 5).

It should be appreciated that while FIG. 4 shows the Acquirer, Association, and Customer's Bank as separate entities, one or more of these entities can be combined.

The AFS server can also transmit an electronic communication to the customer, such as to the customer's mobile phone with information about the status of the transaction and whether the offer was successfully redeemed. Such a communication can comprises a message such as an email, text message, instant message, electronic receipt, and the like confirming that the offer at issue was used or redeemed (step 418 of FIG. 5). The message may include other information such as that the balance, if any, was put on the card. If the transaction was declined, the AFS server does not send a message or sends a message notifying the customer as such (step 419 of FIG. 5).

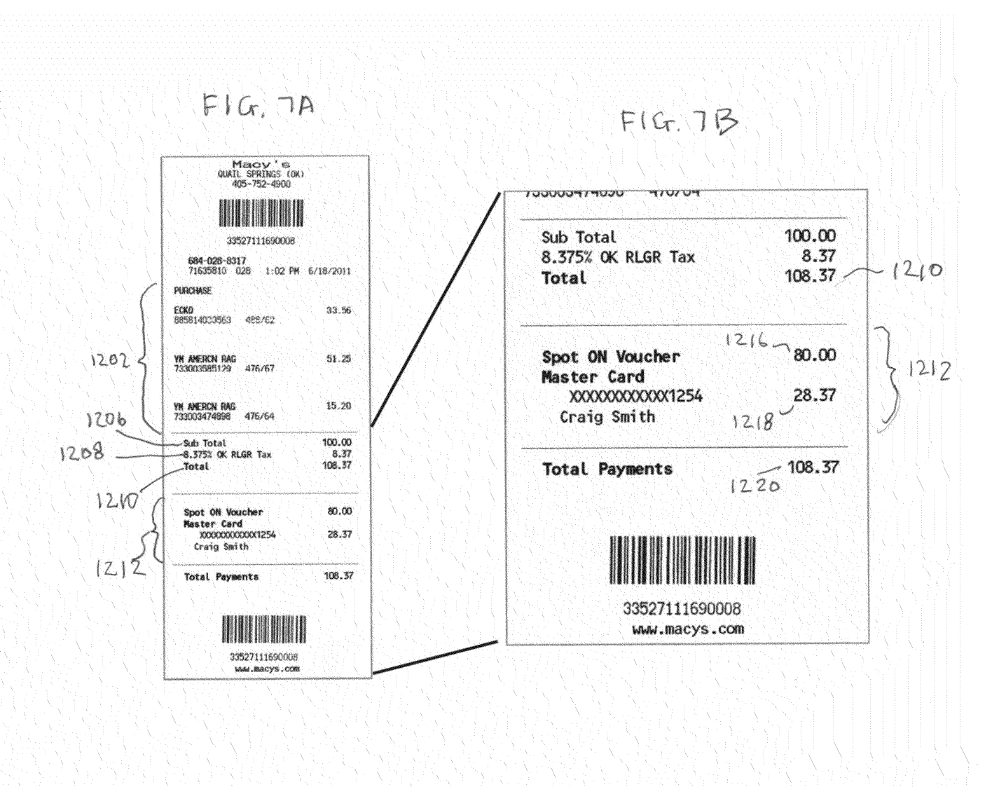

The cardholder can be issued a receipt and/or be sent an electronic message that indicates the amount charged to their card and the amount of the applied offer. FIGS. 7A-B illustrate an exemplary receipt for a purchase totalling $100 to which an offer (the Spot ON Voucher) valued at $80 was applied. The receipt indicates what was purchased 1202, the cost of each item purchased 1204, the sub -total purchase price 1206, other charges such as tax 1208, and the total before any discounts 1210 which is $108.37. The receipt also includes a section 1212 showing the voucher amount 1216 (“Spot ON Voucher $80”) and further indicates that the customer's card was charged only $28.37 1218 which is the sub-total 1210 reduced by the value of the deal 1216. In this exemplary receipt, the “Total Payments”, that is the amount the customer paid plus the value of the voucher, is shown. Note that “Total Payments” (1220) correctly matches the “Total” owed 1210.

Also, the customer may review a summary of their rewards by logging in to their account.

The cardholder can log on to their user account maintained at the AFS server or another server with access to appropriate information view their savings, rewards summary statements, review remaining offers, view reports of which offers were redeemed and when and where, purchase or accept other offers, enter other offers, and electronically link offers to the card product, such as a credit card or debit card.

In this way rebates/offers/coupons/deals can be properly applied or redeemed at the time of a purchase—in real-time—using prior-art gift-card and card product infrastructure.

One way in which a customer can manage various offers and link them to their card is via The Spot ON Deals platform. This platform also enables merchants to provide the right offer to the right customer at the right time using a variety of data analytics methods. Merchants can then monitor the success of those offers through the Spot ON merchant dashboard (“Dashboard”). This allows credit and debit cardholders seamless redemption of Spot ON Deals and other offerings with Coupon-on-a-Card, instead of using traditional paper coupons.

Spot ON Deals allows participating merchants to target the right customer with the right offer at the right time. By way of Dashboard analytics, which provides actionable data by indicating relevant key segment and competitor trends, merchants can use data-driven insights to hone in on key segment and consumer spending trends. Further, Spot ON Deals enable merchants to track the effectiveness of their offers, while deploying follow-on offers to drive repeat purchases, loyalty and customer lifetime value.

In one example, merchants work with representatives from a bank or other financial institution (“FI”) and deal managers to define their offers and target marketing universe. This may be done by way of a Spot ON Merchant Portal which displays a plurality of deal structures available to them.

Financial institutions can promote Spot ON Deals via email, online banking, mobile applications, SMS, direct mail, search, social networks, and other channels. Also consumer-facing budgeting tools show how deals align with a consumer's purchase behavior in key spending categories, such as clothing, restaurants, grocery, travel, and automotive services. Spot ON Deals is redeemable, for example, via paper certificate, mobile applications, and seamless redemption via coupon on a card.

Deals may additionally be delivered to cardholders via their online credit or debit card statement. The Spot ON user interface breaks down card usage by category (e.g. grocery, apparel, travel, personal services, restaurants, automotive/gas, etc.), and provide deals that match recent spending history. In addition to budgeting help from the user interface, cardholders receive relevant deals for merchants that they frequent, as opposed to apparently random offers associated with existing daily deals programs.

In one example of Spot ON, merchant offers that are most likely to be well received by the consumer are offered to the consumer by way of his financial institution. The offers are designed or selected by analyzing a variety of data provided by the merchant and provided by a third-party financial institution.

Regardless of the manner in which an offer, such as a coupon, is targeted to a given consumer, if the consumer accepts the offer, the offer may be linked to the consumer's credit card or debit card (e.g. by pressing a button on a webpage). As discussed above, these coupons-on-a-card may be automatically redeemed at the time of purchaser and instantly deducted at the point of sale. An immediate confirmation of the delivered savings may then be provided on a printed receipt or electronically through a mobile application or text or email message. This is in contrast to a rebate wherein the consumer must pay full price and receive a statement credit later.

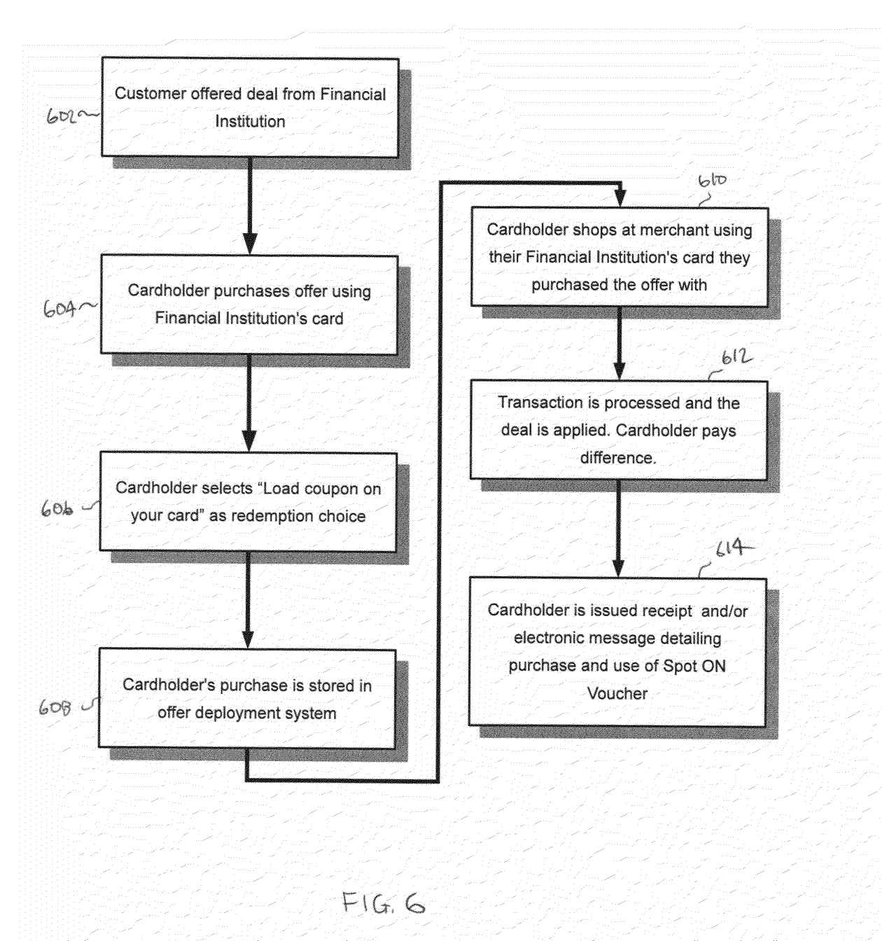

FIGS. 6 illustrates the above in greater detail. A customer is offered a deal 602. For example, the deal may be offered on the website of their financial institution (“FI”). The cardholder accepts the offer 604. Depending on the particular implementation, the cardholder may be led to a web page, pop-up window, or equivalent having a button or equivalent that when clicked links the coupon with the card 606. The offer received in connection with the card is stored on an offer deployment system such as a network connected server having a database 608. This server may later be queried to determine if a discount or other offer should be applied to particular transaction with a particular card.

The cardholder uses the card to purchase a product at a merchant 610. The card is swiped or entered at a POS. There are many POS systems commercially available and their use and configuration is well understood by those having ordinary skill in the art. The transaction is processed and deal applied. The cardholder pays the difference 612 between the purchase price and the seamlessly applied offer.

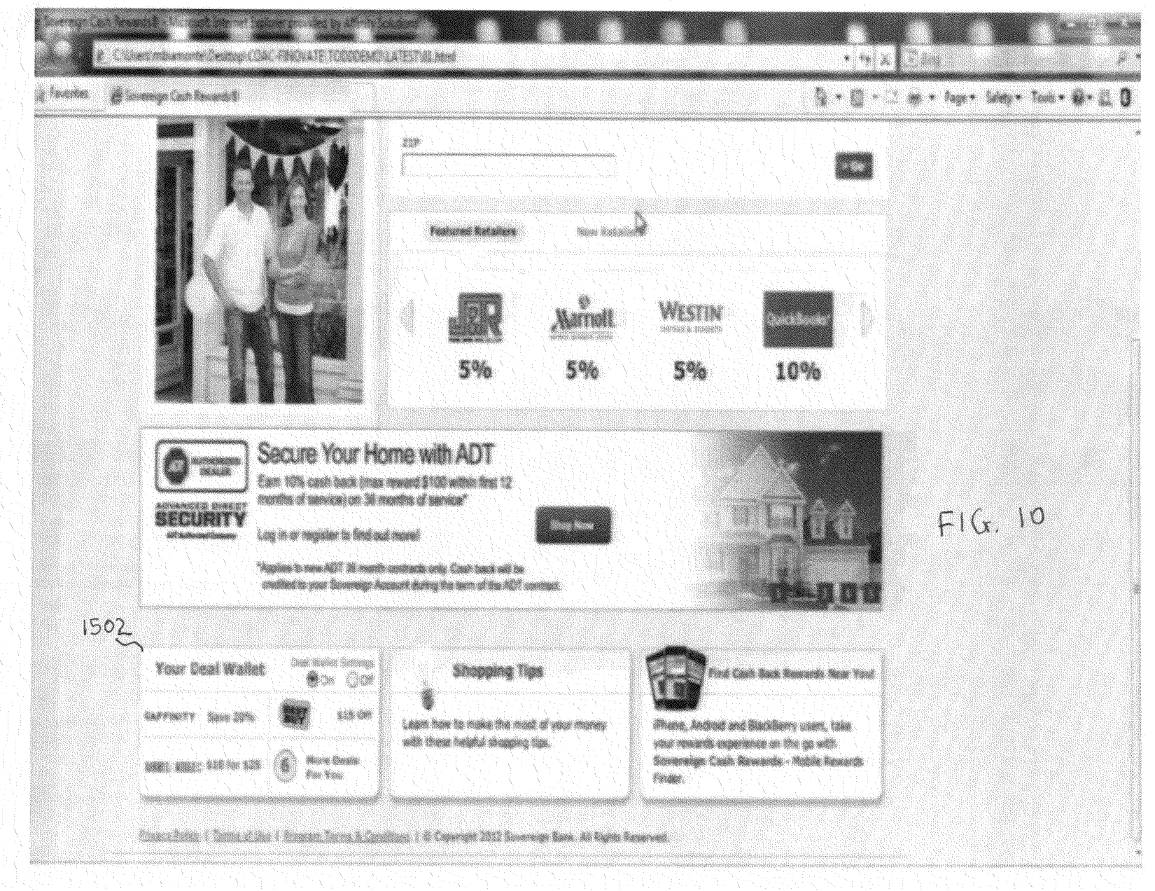

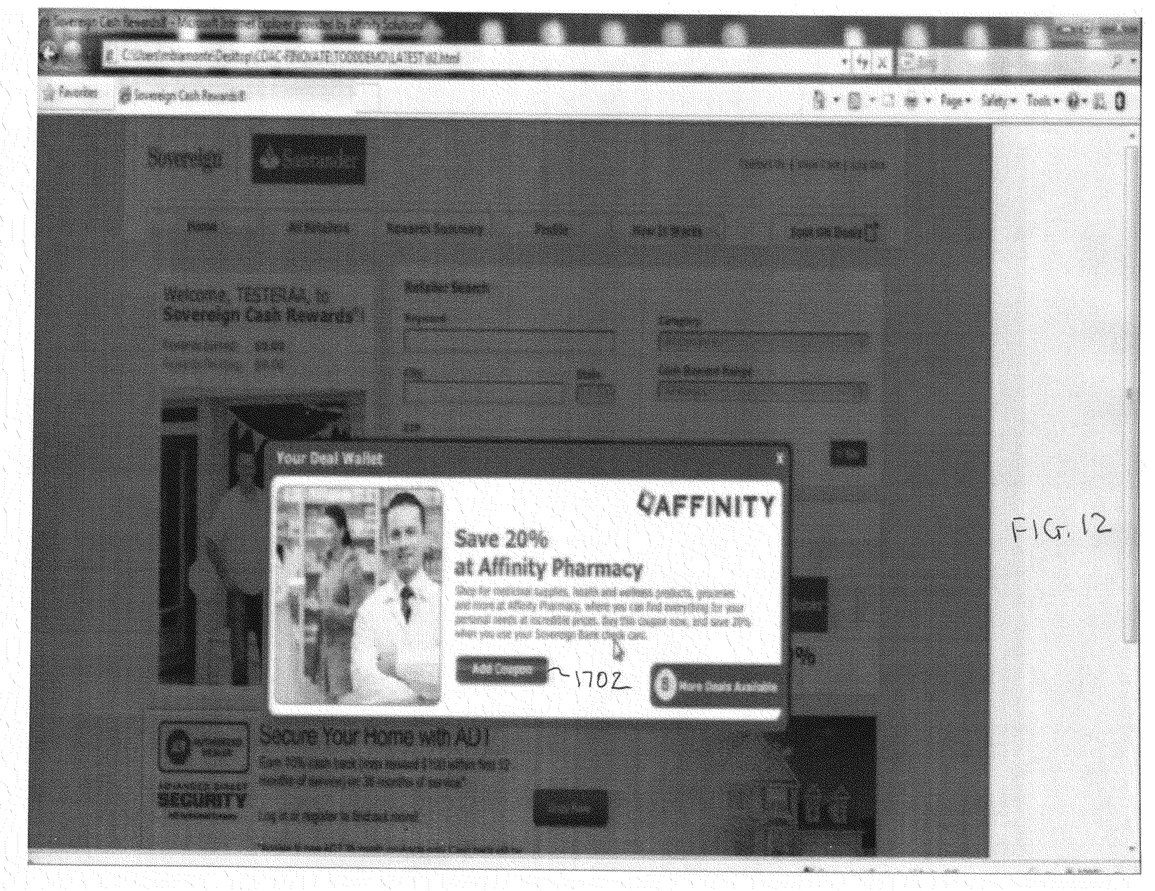

With the above disclosure in mind, FIGS. 10-14 are screenshots showing a merchant funded rewards program. More specifically, these figures illustrate an end-to-end loyalty program for Sovereign Bank (“Bank”).

FIG. 10 shows a customer's account webpage for a bank. The webpage includes a deal wallet 1502. The deal wallet 150 displays offers that are identified and/or created according to the customers profile, purchase history, and other elements above. In one example, offers are provided based on analytics that combine retailer data from a retailer POS and loyalty system with transaction history data source from a financial institution (“FI”).

One exemplary deal includes an offer made for Barnes & Noble. The decision of whether to make the offer to a customer and the structure of the offer can be based on various types of analytics information such as the following:

1) The following data can be obtained from the merchant—Barnes & Noble—and be used to determine if a coupon or other deal should be offered. Two pieces of data obtainable from the merchant are, a) if the customer a member of the B&N loyalty program, and b) if an extended period of time has passed since the customer last visited or purchased something in the store.

2) Other date is available from an FI such as credit card data that shows that the customer has been spending more frequently and in increasing amount at Amazon.com.

In another example, a determination of whether to offer the customer can be a coupon for CVS can be based on:

1) The data from CVS's extra-care loyalty program; and

2) a comparison of that data with transaction data from Sovereign Bank, the FI.

This analysis determines, for example, if the individual is a high-value customer to CVS. “High-value” may mean any number of things but, in any case, they are articulated and though to be important by CVS.

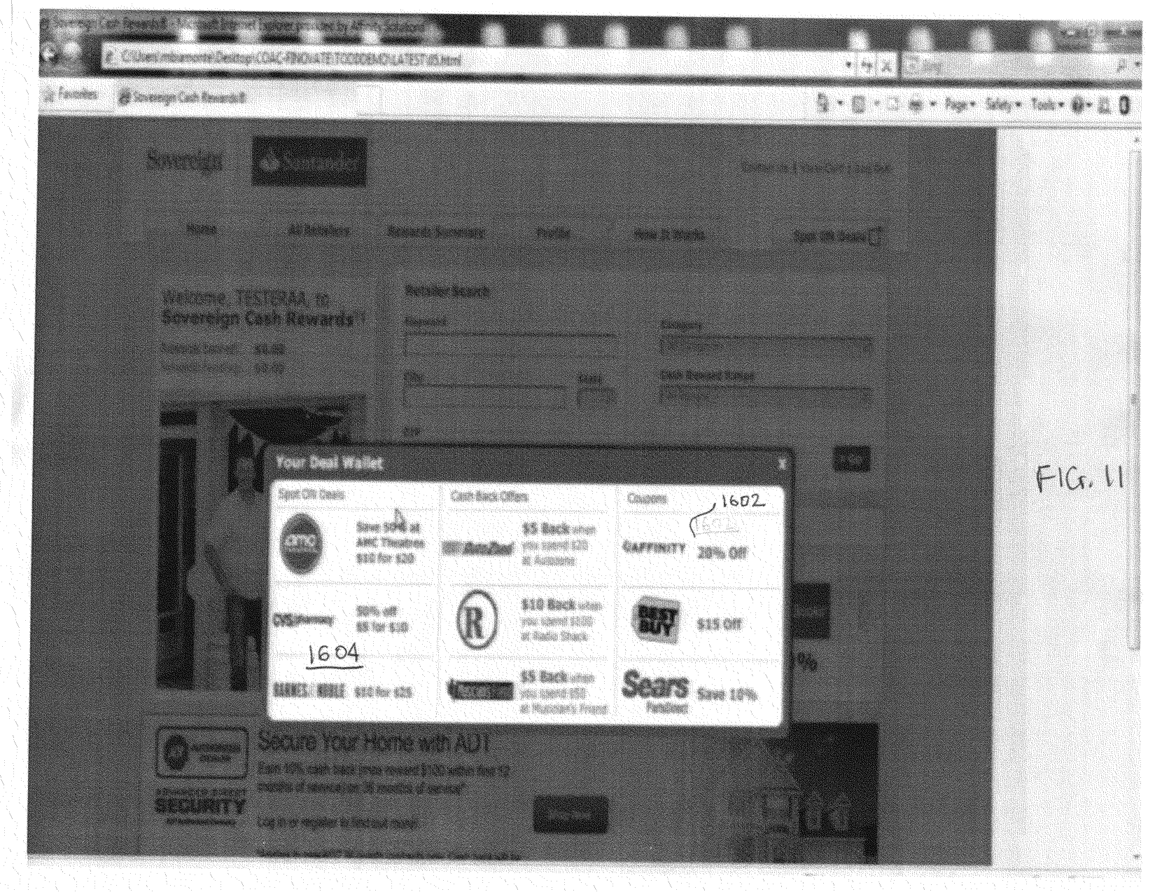

Turning now to FIG. 11, the deal wallet 1502 of FIG. 11 is shown in an expanded view 1604. The deal wallet includes a plurality of offers including an offer for a 20% discount at Affinity Pharmacy (“Pharmacy”). As already disclosed, the offer can be made by:

1) obtaining information about the customer from retailer;

2) obtaining transaction data related to customer, for example by obtaining and analyzing data from a financial institution such as a issuing bank;

3) targeted offers according to an analysis of (1) and (2) above are then selected or created and dispayed in “Your Deal Wallet” 1604 of FIG. 11;

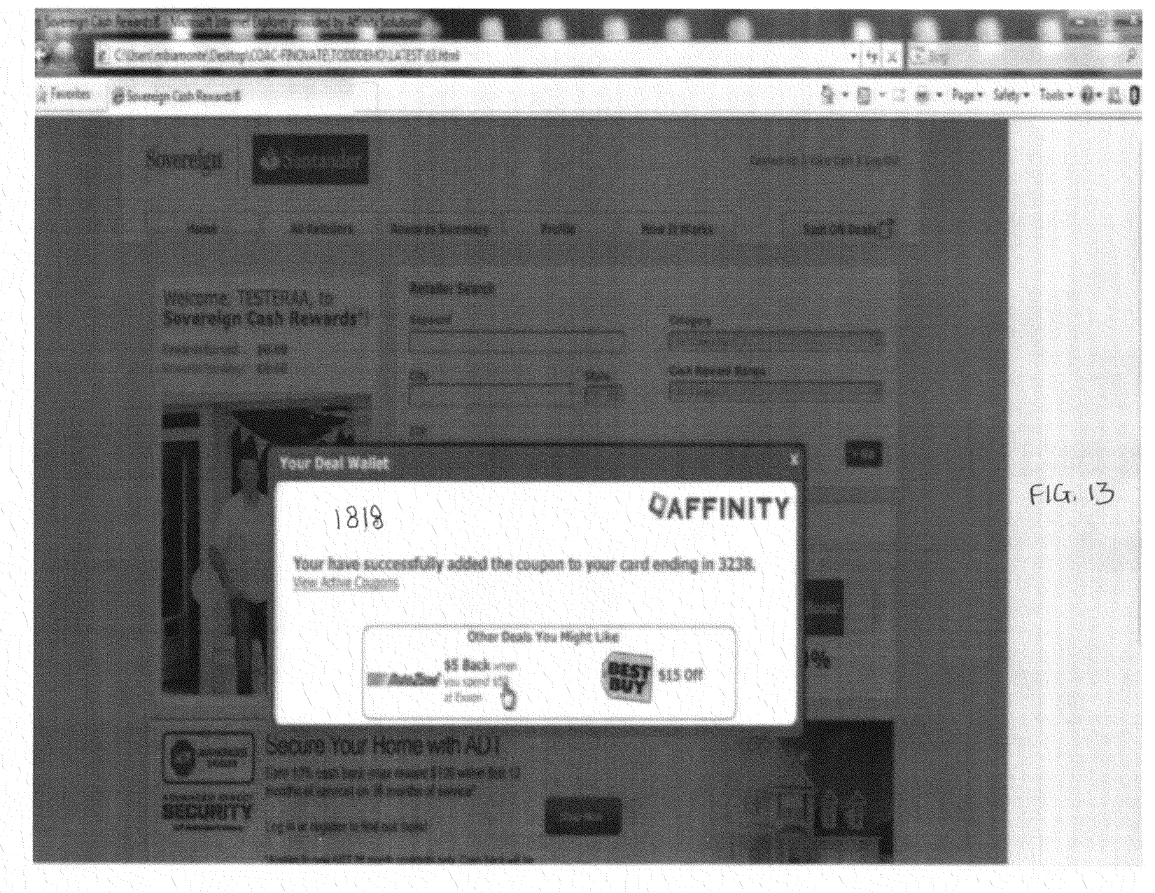

4FIG. 12 shows an expanded view of a deal selected by the user. As shown in the figure, the coupon includes an “Add Coupon” button 1702 that when clicked upon adds the coupon 1818 to the customer's card, the result of which is shown in FIG. 13 By adding the coupon, the customer's account number and/or other electronic identifying information and the Pharmacy's merchant ID number are loaded into a lookup table for the merchant acquirer to access real-time as part of the authorization stream (See discussions of FIGS. 4 and 5, above).

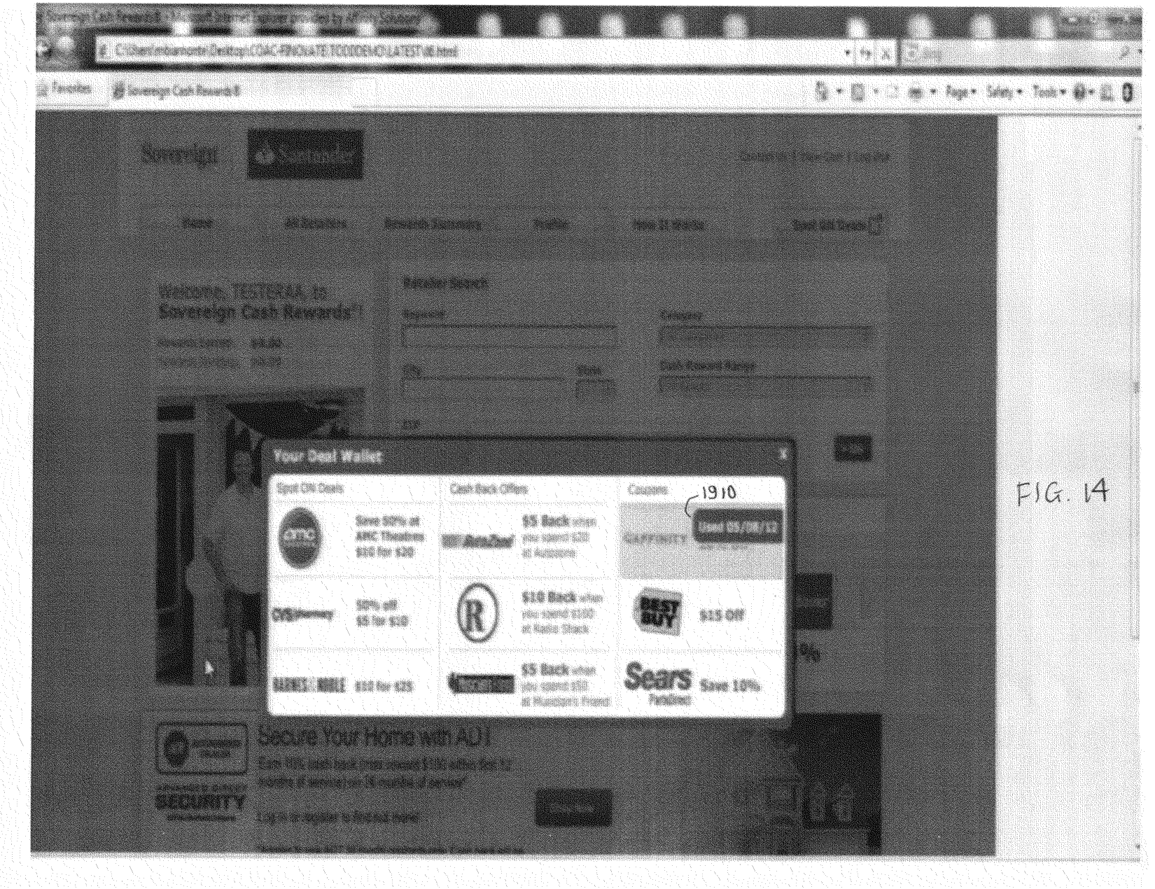

The deal wallet can indicate the status of the deal, such as “Used” 1910 of FIG. 14.

Turning back to FIGS. 4,5, the coupon may be used as follows:

1) The customer gives card to the merchant for purchase;

2) The merchant swipes card. The POS terminal, terminal is keyed to drive transactions to the merchant (e.g. the Pharmacy).

4) The merchant enters amount (e.g. $10) and other information typically entered by a merchant for a card-based purchase.

5) A Request is made to authorize the transaction. This can be enabled through by collaborating with a FI.

6) An authorization is received by the merchant.

7) The delivered saving are confirmed received. For example, a print receipt showing Point-of-Sale discount that occurred real-time —wherein the card is only charged the purchase amount less the offer amount,. As already disclosed, the receipt can show the Sale Amount, Offer Amount, Coupon Description, Total Amount/Sale Amount, and amessage reinforcing that coupon was given to customer based on customer's participation with Sovereign Cash Rewards (e.g. “Thank you for your business! Your 20% Spot On Coupon is courtesy of Sovereign Cash Rewards.”). Also, an electronic message may be sent to the customer, such as by email, text, and the like.

The methods and systems may be implemented on any computer communicating over any network. For example the computers may include desktop computers, tablets, handheld devices, laptops and mobile devices. The mobile devices may comprise many different types of mobile devices such as cell phones, smart phones, PDAs, portable computers, tablets, and any other type of mobile device operable to transmit and receive electronic messages.

The computer network(s) may include the internet and wireless networks such as a mobile phone network. Any reference to a “computer” is understood to include one or more computers operable to communicate with each other. Computers and devices comprise any type of computer capable of storing computer executable code and executing the computer executable code on a microprocessor, and communicating with the communication network(s). For example computer may be a web server.

References to electronic identifiers may be used which include, but are not limited to, email addresses, mobile phone numbers, user IDs for instant messaging services, user IDs for social networking application or mobile applications, user IDs and URLs for blogs and micro-blogs, URIs, bank account or financial institution numbers, routing numbers, credit and debit cards, any computer readable code, and other electronic identifiers to identify accounts, users, companies, and the like.

The systems and methods may be implemented on an Intel or Intel compatible based computer running a version of the Linux operating system or running a version of Microsoft Windows, Apple OS, and other operating systems. Computing devices based on non-Intel processors, such as ARM devices may be used. Various functions of any server, mobile device or, generally, computer may be implemented in hardware and/or in software, including in one or more signal processing and/or application specific integrated circuits.

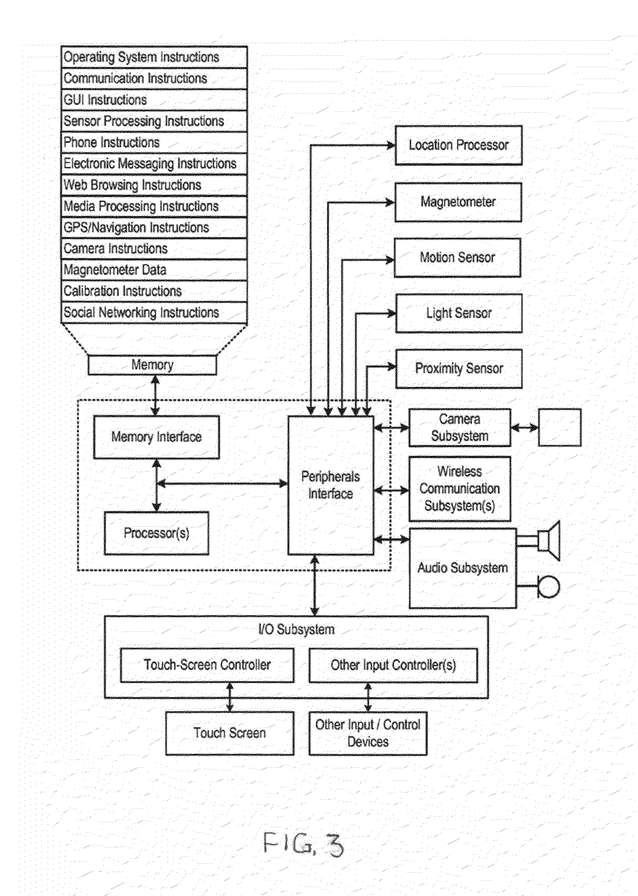

FIG. 3 shows the architecture and components of an exemplary mobile device. Products such as an iPhone, an Android phone, and many others are comprised as shown in FIG. 3. Furthermore, laptop and desktop computers also share many of the same components and arrangement of components.

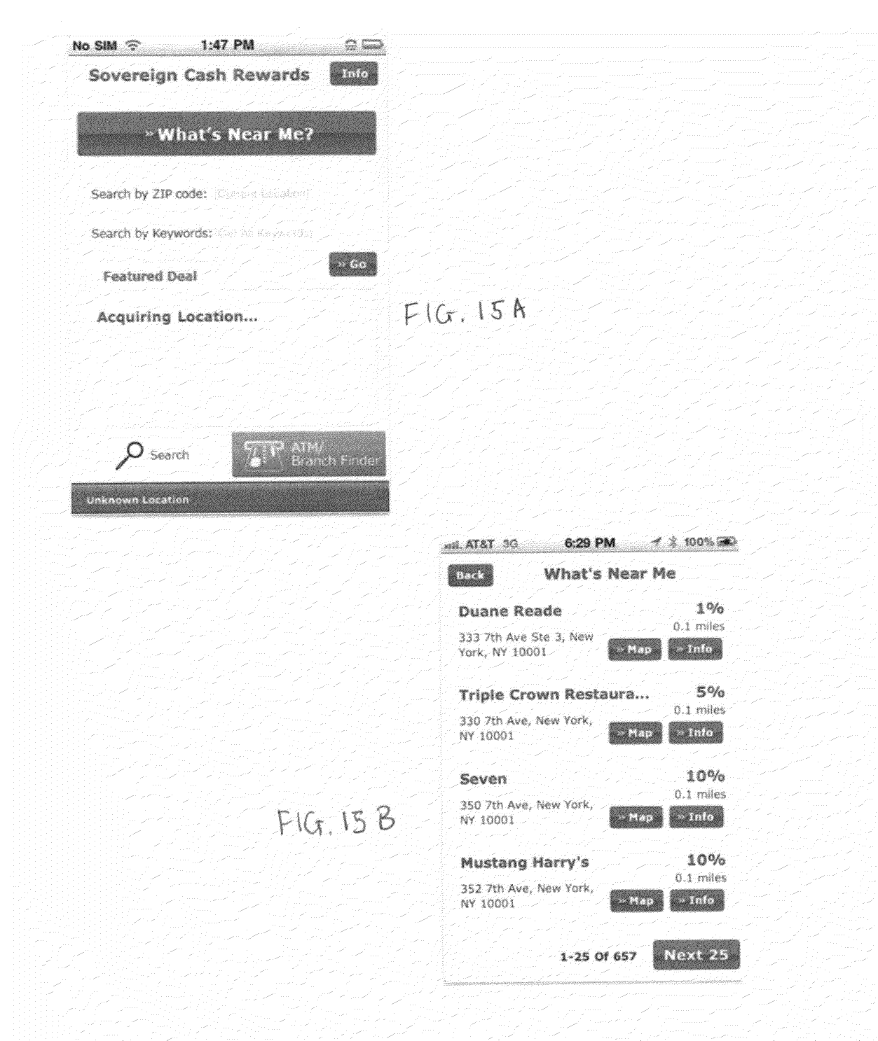

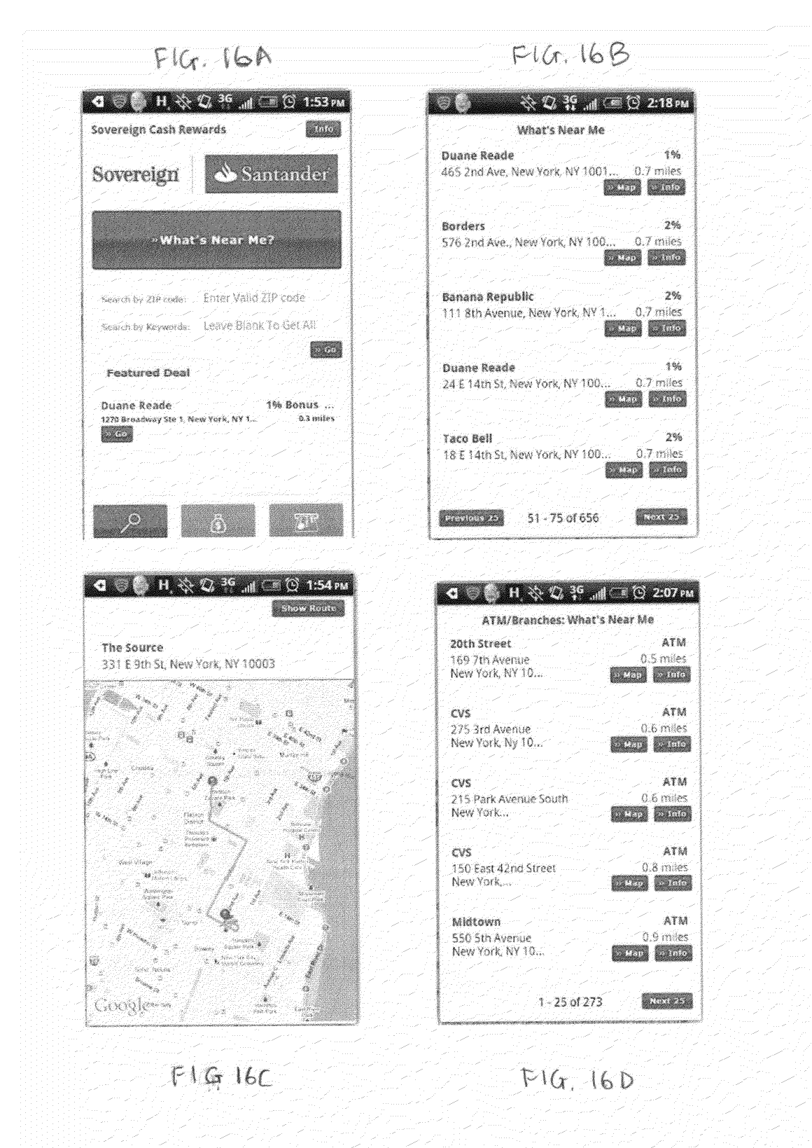

FIGS. 15A, 15B, 16A, 16B, and 16C are exemplary screenshots of a mobile application running on the exemplary mobile computing device of FIG. 3 such as an iPhone and Android phone. In one example, the application communicates with a server (for example 480 of FIG. 4) to find geographically relevant deals. In another example, the application communicates with the issuing bank server and Spot ON Deals are delivered to the mobile device, which are then displayed on the screen of the device. The applications can include many other function as shown in FIGS. 15 and 16 and as should now be appreciated by those having ordinary skill in the art.

The computers and, equivalently, mobile devices may include any and all components of a computer such as storage like memory and magnetic storage, interfaces like network interfaces, and microprocessors. For example, a computer comprises some of all of the following: a processor in communication with a memory interface (which may be included as part of the processor package) and in communication with a peripheral interface (which may also be included as part of the processor package); the memory interface is in communication via one or more buses with a memory (which may be included, in whole or in part, as part of the processor package; the peripheral interface is in communication via one or more buses with an input/output (I/O) subsystem; the I/O subsystem may include, for example, a graphic processor or subsystem in communication with a display such as an LCD display, a touch screen controller in communication with a touch sensitive flat screen display (for example, having one or more display components such as LEDs and LCDs including sub-types of LCDS such as IPS, AMOLED, S-IPS, FFS, and any other type of LCD; the I/O subsystem may include other controllers for other I/O devices such as a keyboard; the peripheral interface may be in communication with either directly or by way of the I/O subsystem with a storage controller in communication with a storage device such a hard drive, non-volatile memory, magnetic storage, optical storage, magneto-optical storage, and any other storage device capable of storing data; the peripheral interface may also be in communication via one or more buses with one or more of a location processor such as a GPS and/or radio triangulation system, a magnetometer, a motion sensor, a light sensor, a proximity sensor, a camera system, wireless communication subsystem(s), and audio subsystems.

A non-transitory computer readable medium, such as the memory and/or the storage device(s) includes/stores computer executable code which when executed by the processor of the computer causes computer to perform a series of steps, processes, or functions. The computer executable code may include, but is not limited to, operating system instructions, communication instruction, GUI (graphical user interface) instructions, sensor processing instructions, phone instructions, electronic messaging instructions, web browsing instructions, media processing instructions, GPS or navigation instructions, camera instructions, magnetometer instructions, calibration instructions, an social networking instructions.

An application programming interface (API) permits the systems and methods to operate with other software platforms such as Salesforce CRM, Google Apps, Facebook, Twitter, social networking sites, desktop and server software, web applications, mobile applications, and the like. For example, an interactive messaging system could interface with CRM software and GOOGLE calendar.

A computer program product may include a non-transitory computer readable medium comprising computer readable code which when executed on the computer causes the computer to perform the methods described herein. Databases may comprise any conventional database such as an Oracle database or an SQL database. Multiple databases may be physically separate, logically separate, or combinations thereof.

The features described can be implemented in any digital electronic circuitry, with a combination of digital and analogy electronic circuitry, in computer hardware, firmware, software, or in combinations thereof. The features can be implemented in a computer program product tangibly embodied in an information carrier (such as a hard drive, solid state drive, flash memory, RAM, ROM, and the like), e.g., in a machine-readable storage device or in a propagated signal, for execution by a programmable processor; and method steps can be performed by a programmable processor executing a program of instructions to perform functions and methods of the described implementations by operating on input data and generating output(s).

The described features can be implemented in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any type of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. Some elements of a computer are a processor for executing instructions and one or more memories for storing instructions and data. Generally, a computer will also include, or communicate with one or more mass storage devices for storing data files. Exemplary devices include magnetic disks such as internal hard disks and removable disks, magneto-optical disks, and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) for displaying information to the user and a keyboard and a pointing device such as a mouse or a trackball by which the user can provide input to the computer. The display may be touch sensitive so the user can provide input by touching the screen.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wired and wireless packetized networks, and the computers and networks forming the Internet.

The foregoing detailed description has discussed only a few of the many forms that this invention can take. It is intended that the foregoing detailed description be understood as an illustration of selected forms that the invention can take and not as a definition of the invention. It is only the claims, including all equivalents, that are intended to define the scope of this invention.

What is claimed is:

1. A coupon on a card method for redeeming an offer comprising the steps of:
providing a card product issued by a financial institution to a cardholder;
providing an offer, wherein the offer is a coupon;
transmitting the offer from a financial institution server to an electronic device of the cardholder;
receiving from the cardholder purchase information indicating that the cardholder purchased the offer;
receiving a redemption choice from the cardholder, wherein the redemption choice is to load the coupon on the cardholder's card product;
storing the cardholder's purchase information in an offer deployment system;
receiving a transaction approval request from at least one of: a merchant, an acquirer, an association, a bank, an issuer;
processing the transaction approval request, wherein the step of processing comprises at least one of querying the offer deployment system, approving the transaction, and applying the value of the offer; and
issuing a receipt to the cardholder wherein the receipt indicates the purchase and use of the coupon.
